(19) United States
(12) Patent Application Publication
(10) Pub. No.: US 2026/0349511 A1
(43) Pub. Date: Nov. 5, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: EMIRI SAKIYAMA, TOKYO (JP); KAZUNOBU OOKURI, TOKYO (JP); RYO YOKOYAMA, TOKYO (JP); YUSUKE NAKAGAWA, TOKYO (JP); HIROTO KAWAGUCHI, TOKYO (JP)

(21) Appl. No.: 19/118,886

(22) PCT Filed: Aug. 31, 2023
(86) PCT No.: PCT/JP2023/031896

§ 371 Date: Apr. 7, 2025

(30) Foreign Application Priority Data
Oct. 13, 2022 (JP) 2022-164797

(51) Int. Cl. G06F 3/01

(52) U.S. Cl. CPC G06F 3/016

(57) ABSTRACT

[Object] To provide an information processing apparatus, an information processing method, and a program that make it possible to reduce a data amount necessary for presentation of a haptic sensation.

[Solving Means] An information processing apparatus that includes a controller that performs control including determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished; and generating a control signal used to drive driving-target haptic presentation sections sequentially.

### TECHNICAL FIELD

The present disclosure relates to an information processing apparatus, an information processing method, and a program.

### BACKGROUND ART

Technologies used to present haptic stimulation to a user in the form of, for example, vibration have been proposed in the past.

For example, Patent Literature 1 indicated below discloses a technology used to reduce a data amount using a phantom sensation or apparent movement that corresponds to a higher-order haptic perception. The phantom sensation refers to a phenomenon in which, when haptic stimulation is presented to each of different locations on a skin of a user at the same time, this results in causing the user to feel as if the haptic stimulation were presented at a location situated between the different locations. The apparent movement refers to a phenomenon in which, due to a separate chronological movement of a stimulation point, stimulation is inserted between stimulation points and this results in causing a user to feel as if the stimulation point were continuously moving on a skin of the user.

Patent Literature 2 indicated below discloses a technology used to control output of stimulation when haptic stimulation is perceived at a desired location using a phantom sensation, in order to maintain a strength of perception.

### CITATION LIST

### Patent Literature

Patent Literature 1: WO 2020/003727

Patent Literature 2: WO 2018/008217

### DISCLOSURE OF INVENTION

### Technical Problem

The above-described technologies used to present haptic stimulation provide a wide range of tactile representation by increasing the number of body parts to which haptic stimulation is provided. However, this results in increasing the number of channels of a haptic signal, and thus in increasing a data amount. The increase in a data amount of a haptic signal results in, for example, a reduction in a speed of processing performed to present a haptic sensation, and an increase in transmission delay. This is not favorable.

### Solution to Problem

The present disclosure provides an information processing apparatus that includes a controller that performs control including determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished; and generating a control signal used to drive driving-target haptic presentation sections sequentially.

Further, the present disclosure provides an information processing method that is performed by a processor, the information processing method including determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished; and generating a control signal used to drive driving-target haptic presentation sections sequentially.

Furthermore, the present disclosure provides a program that causes a computer to operate as a controller that performs control including determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished, and; generating a control signal used to drive driving-target haptic presentation sections sequentially.

### BRIEF DESCRIPTION OF DRAWINGS

FIG. 1 illustrates a configuration of a haptic presentation system 1 according to an embodiment of the present disclosure.

FIG. 2 is a diagram used to describe determination of a driving-omission channel according to a movement speed of a perceptual location in the present embodiment.

FIG. 3 is a diagram used to describe driving of a channel according to a movement speed of a perceptual location in the present embodiment.

FIG. 4 is a flowchart illustrating an example of how operation processing is performed by the haptic presentation system 1 in the present embodiment.

FIG. 5 is a diagram used to describe driving of a channel according to a first modification of the present embodiment.

FIG. 6 is a diagram used to describe a change in strength of perception according to the first modification of the present embodiment.

FIG. 7 is a diagram used to describe driving of a channel according to a second modification of the present embodiment.

FIG. 8 is a diagram used to describe a degree of contact of the haptic presentation section 210 with skin according to a third modification of the present embodiment.

### MODE(S) FOR CARRYING OUT THE INVENTION

Favorable embodiments of the present disclosure will now be described below in detail with reference to the accompanying drawings. Note that, in the specification and the drawings, structural elements having substantially the same functional configuration are denoted by the same reference numeral to omit a repetitive description.

Further, the description will be made in the following order.
1. Configuration of Haptic Presentation System
2. Operation Processing
3. Modifications
   3-1. First Modification
   3-2. Second Modification
   3-3. Third Modification
   3-4. Fourth Modification
4. Supplement

### 1. Configuration of Haptic Presentation System

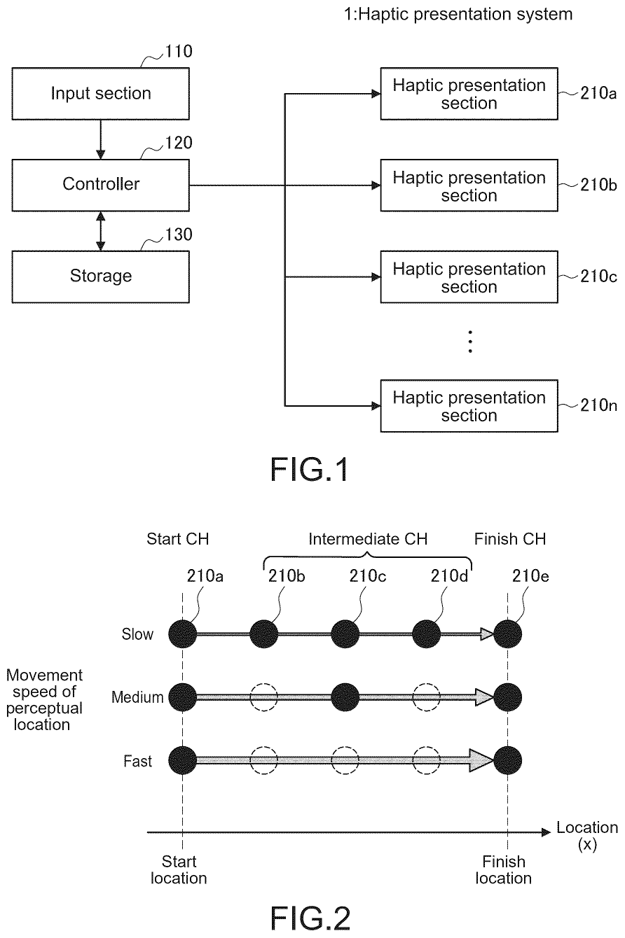

Frist, a haptic presentation system 1 according to an embodiment of the present disclosure is described with reference to FIG. 1. FIG. 1 illustrates a configuration of the haptic presentation system 1 according to the embodiment of the present disclosure. As illustrated in FIG. 1, the haptic presentation system 1 includes an input section 110, a controller 120, a storage 130, and a haptic presentation section 210. A plurality of haptic presentation sections 210 is provided (the haptic presentation sections 210a to 210n), and the plurality of haptic presentation sections 210 provides haptic stimulation to a plurality of parts of a human body under the control of the controller 120.

The haptic presentation system 1 may be implemented by a single apparatus (an information processing apparatus) or by a plurality of apparatuses. For example, the haptic presentation system 1 may be implemented by an information processing apparatus and a haptic presentation device, where the information processing apparatus includes the input section 110, the controller 120, and the storage 130, and the haptic presentation device includes a plurality of haptic presentation sections 210.

### 1-1. Input Section 110

The input section 110 includes a function of acquiring a haptic signal and inputting the haptic signal to the controller 120. The haptic signal may be data stored using a tactile sensor, may be data for which a necessary parameter is set discretionarily, or may be data based on information regarding a motion or operation performed by a user. The haptic signal includes a perceptual location, a strength of perception, and chronological data of the perceptual location and the strength of perception, where the perceptual location and the strength of perception are a location of and a strength of perception at the time of presenting a haptic sensation. The input section 110 may be a communication section that receives a haptic signal from an external apparatus, or may be a generator that generates a haptic signal.

### 1-2. Storage 130

The storage 130 is implemented by a read only memory (ROM) and a random access memory (RAM), where the ROM stores therein, for example, a program and a computation parameter that are used for processing performed by the controller 120, and the RAM temporarily stores therein, for example, a parameter that varies as necessary. The storage 130 may store therein a haptic signal.

### 1-3. Haptic Presentation Section 210

The haptic presentation section 210 outputs haptic stimulation in the form of, for example, vibration in accordance with a control signal input by the controller 120. Examples of the type of haptic stimulation include vibration, pressure, and warmth/coldness. In the present embodiment, it is assumed, as an example, that the haptic presentation section 210 outputs haptic stimulation using vibration.

At least three haptic presentation sections 210 may be provided. The plurality of haptic presentation sections 210 may be provided to a haptic presentation device that can be touched by a body of a user. The type of the haptic presentation device is not particularly limited, and examples of the type of the haptic presentation device include wearing-type devices such as gloves, a vest, trousers, a hat, socks, and shoes; and holding-type devices such as a mouse and a controller. A body part to which a haptic sensation is presented is also not particularly limited, and examples of the body part include a hand, a fingertip, and a trunk.

Here, a wider range of tactile representation can be provided in general if the number of haptic presentation sections provided to a haptic presentation device is larger (the number of stimulation points is made larger), as described above. When, for example, the haptic presentation device is a vest worn on a trunk of a user, a large number of haptic presentation sections may be arranged on each of a front surface and a back surface of the vest. Further, when, for example, the haptic presentation device is a glove worn on a hand of a user, a large number of haptic presentation sections may be arranged on each of, for example, a palm of the hand, the back of the hand, and a pad of a finger. However, the increase in the number of haptic presentation sections results in increasing the number of channels of a haptic signal, and thus in increasing a data amount. The increase in data amount results in, for example, a reduction in a speed of processing performed to present a haptic sensation, and an increase in transmission delay. In the present embodiment, a data amount is reduced using an apparent movement described below, and this makes it possible to reduce the possibility of, for example, the reduction in processing speed and the increase in transmission delay.

### 1-4. Controller 120

The controller 120 serves as an arithmetic processing apparatus and a control apparatus, and controls an overall operation performed in the haptic presentation system 1 in accordance with various programs. For example, the controller 120 is implemented by an electronic circuit such as a central processing unit (CPU) or a microprocessor. Further, the controller 120 may include a ROM and a RAM, where the ROM stores therein, for example, a program and a computation parameter that are used by the controller 120, and the RAM temporarily stores therein, for example, a parameter that varies as necessary.

The controller 120 acquires a haptic signal from the input section 110 or the storage 130, and generates, on the basis of the haptic signal, a control signal used to control the haptic presentation section 210. In this case, the controller 120 reduces a data amount using an apparent movement. Specifically, when the haptic signal is a signal that indicates movement of a perceptual location and when there are at least three haptic presentation sections 210, the controller 120 determines, according to a movement speed of the perceptual location acquired from the haptic signal, the haptic presentation section 210 of which driving is to be omitted (hereinafter also referred to as a driving-omission channel). The haptic presentation section 210 of which driving is to be omitted is determined from among at least one haptic presentation section 210 situated between the haptic presentation section 210 corresponding to a start location at which presentation of a haptic sensation is started and the haptic presentation section 210 corresponding to a finish location at which the presentation of a haptic sensation is finished. The movement speed may be included in a haptic signal, or may be calculated by the controller 120 on the basis of the haptic signal.

FIG. 2 is a diagram used to describe determination of a driving-omission channel according to a movement speed of a perceptual location in the present embodiment. When movement of a perceptual location indicated by a haptic signal is movement from a haptic presentation section 210a to a haptic presentation section 210e, as illustrated in FIG. 2, channels that may be controlled (driven) by the controller 120 (a driving-target channel) include a start channel (Start CH) that corresponds to the haptic presentation section 210a provided at a location at which presentation of haptic stimulation is started, a finish channel (Finish CH) that corresponds to the haptic presentation section 210e provided at a location at which the presentation of haptic stimulation is finished, and an intermediate channel (Intermediate CH) that corresponds to each of haptic presentation sections 210b to 210d situated between the haptic presentation section 210a and the haptic presentation section 210e.

The haptic presentation sections 210a to 210e are the haptic presentation sections 210 situated on a movement route of a perceptual location indicated by a haptic signal. From among a large number of haptic presentation sections 210 provided to a haptic presentation device, the haptic presentation sections 210a to 210e corresponding to the movement route may be designated by the haptic signal, or may be determined by the controller 120 on the basis of the perceptual location indicated by the haptic signal and arrangement of the haptic presentation sections 210.

From among at least one haptic presentation section 210b, 210c, 210d (hereinafter also referred to as an intermediate channel) situated between the haptic presentation section 210a corresponding to a start location at which presentation of a haptic sensation is started and the haptic presentation section 210e corresponding to a finish location at which the presentation of a haptic sensation is finished, the controller 120 determines, according to a movement speed of a perceptual location, the haptic presentation section 210 of which driving is to be omitted (a driving-omission channel).

More specifically, when, for example, the movement speed is less than a first specified value (“movement speed: slow” illustrated in FIG. 2), the controller 120 does not omit driving of an intermediate channel (no channels of which driving is to be omitted). In this case, the controller 120 drives all of the channels (the haptic presentation section 210a to the haptic presentation section 210e).

Further, when the movement speed is greater than the first specified value (“movement speed: medium” illustrated in FIG. 2), the controller 120 omits driving of a portion of the intermediate channels (the haptic presentation sections 210b to 210d). Which of the intermediate channels is omitted may be determined in accordance with a rule defined in advance. For example, the controller 120 may determine, for example, every other or every third channel as a driving-omission channel. In the example illustrated in FIG. 2, two channels corresponding to the haptic presentation section 210b and the haptic presentation section 210d are determined to be driving-omission channels.

Further, when the movement speed is greater than a second specified value that is larger than the first specified value (“movement speed: high” illustrated in FIG. 2), the controller 120 omits driving of all of the intermediate channels (three channels corresponding to the haptic presentation sections 210b to 210d). In other words, the controller 120 determines all of the intermediate channels as driving-omission channels, and only drives the haptic presentation section 210a corresponding to the start location and the haptic presentation section 210e corresponding to the finish location.

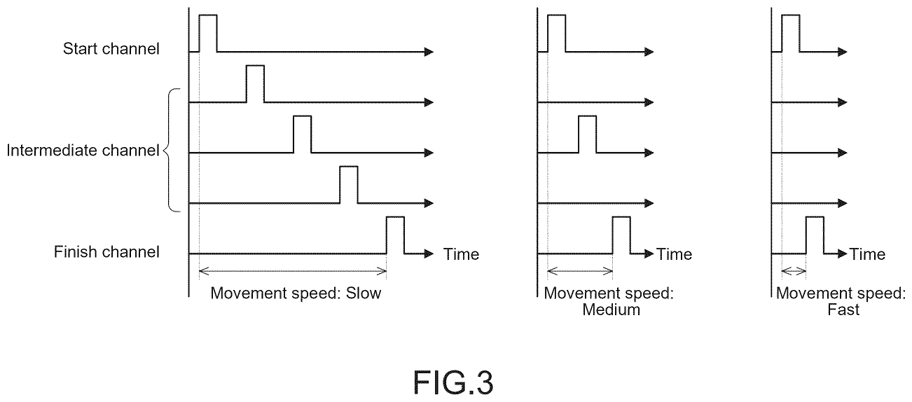

FIG. 3 is a diagram used to describe driving of a channel according to a movement speed of a perceptual location in the present embodiment. As illustrated in FIG. 3, the controller 120 drives the haptic presentation section 210 by generating instantaneous haptic stimulation in a start channel and in a finish channel in this order. Further, with respect to the intermediate channel, driving of the haptic presentation section 210 is omitted as appropriate according to the movement speed, as described above.

The controller 120 outputs, to each driving-target haptic presentation section 210, a control signal used to drive the haptic presentation section 210. The controller 120 may transmit a control signal by establishing communication connection by wire or wirelessly with a haptic presentation device including a plurality of haptic presentation sections 210.

Here, even if the controller 120 omits at least a portion of intermediate channels according to a movement speed of a perceptual location, a user may perceive as if the perceptual location were continuously moving on a skin of the user, due to the above-described apparent movement corresponding to a higher-order haptic perception. In the present embodiment, the omission of at least a portion of intermediate channels makes it possible to reduce a data amount necessary for presentation of a haptic sensation (recreation of a haptic sensation) while securing the ability to recreate a haptic sensation, as described above.

A reduction in data amount makes it possible to reduce the possibility of, for example, a reduction in processing speed and an increase in transmission delay. Further, when power consumption in the haptic presentation system 1 is reduced due to the reduction in data amount, there is an increase in a period of time for which a haptic sensation presented by the haptic presentation system 1 can be experienced. Further, this makes it possible to provide tactile representation that is not dependent only on an increase in the number of stimulation points. This results in a reduction in costs for a vibration device.

Note that the first specified value and second specified value described above may differ depending on spacing of arrangement of the respective haptic presentation sections 210 (that is, distances between the respective haptic presentation sections 210). Further, in the example described with reference to FIGS. 2 and 3, the movement speed is classified into three levels, and a channel of which driving is to be omitted is represented by “no channels”, “a portion of channels”, or “all of channels”, although the present disclosure is not limited thereto. Further, the number of channels of which driving is to be omitted is not particularly limited. When the controller 120 omits driving of a portion of intermediate channels, the controller 120 may determine, for example, every other or every third channel as a driving-omission channel according to at least one of a movement speed, spacing of arrangement of (distances between) the respective haptic presentation sections 210, or the number of driving-target channels.

The configuration of the haptic presentation system 1 has been specifically described above. Note that the configuration of the haptic presentation system 1 in the present embodiment is not limited to the example illustrated in FIG. 1.

### 2. Operation Processing

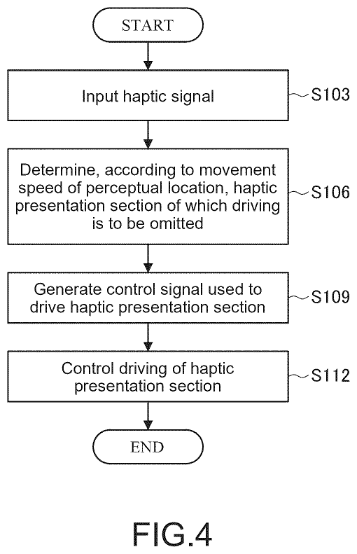

Next, operation processing performed by the haptic presentation system 1 according to the present embodiment is described with reference to FIG. 4. FIG. 4 is a flowchart illustrating an example of how the operation processing is performed by the haptic presentation system 1 in the present embodiment.

First, the input section 110 inputs a haptic signal to the controller 120, as illustrated in FIG. 4 (Step S103).

Next, the controller 120 determines, according to a movement speed of a perceptual location, the haptic presentation section 210 of which driving is to be omitted (Step S106). From among at least one haptic presentation section 210 situated between the haptic presentation section 210 corresponding to a start location at which presentation of a haptic sensation is started and the haptic presentation section 210 corresponding to a finish location at which the presentation of a haptic sensation is finished, the controller 120 determines the haptic presentation section 210 of which driving is to be omitted. This makes it possible to reduce a data amount necessary for presentation of a haptic sensation.

Next, the controller 120 generates a control signal used to drive the haptic presentation section 210 (Step S109).

Then, the controller 120 transmits the control signal to the haptic presentation section 210 to control driving of the haptic presentation section 210 (Step S112).

The operation processing performed in the present embodiment has been described above. Note that the operation processing illustrated in FIG. 4 is merely an example, and the present disclosure is not limited thereto.

### 3. Modifications

Next, modifications of the present embodiment are described.

### 3-1. First Modification

When spacing of arrangement of locations at which a haptic sensation is presented (locations of the haptic presentation sections 210 to be driven) exhibits a value greater than a specified value relative to a movement speed due to the above-described omission of driving, a user feels, due to an apparent movement, as if a perceptual location were moving. However, it is conceivable that there could be a reduction in the quality of perceptual representation such as the continuity or smoothness of the movement of the perceptual location, compared to before omission of driving. Thus, in a first modification, when the controller 120 omits driving of at least a portion of intermediate channels, the controller 120 makes a driving period of time (a period of time for which a haptic sensation is presented) longer than a period of time indicated by a haptic signal. This makes it possible to reduce the possibility of a reduction in the quality of perceptual representation, compared to before omission of driving.

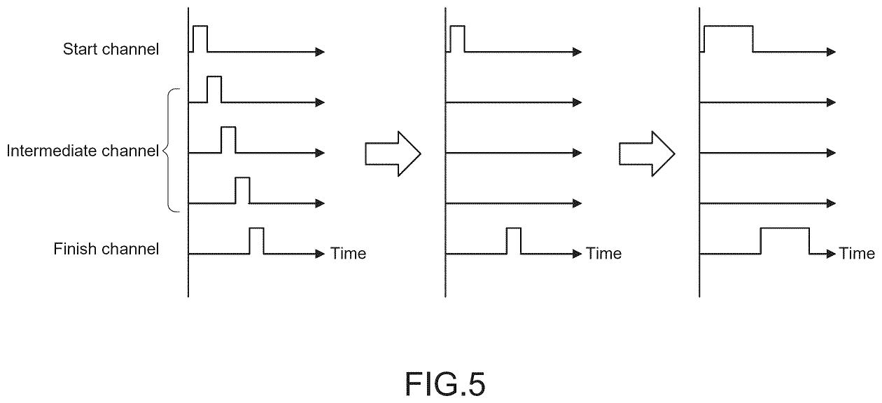

FIG. 5 is a diagram used to describe driving of a channel according to the first modification of the present embodiment. When driving is not omitted, all of a start channel, intermediate channels, and a finish channel are driven, as illustrated on the left in FIG. 5. On the other hand, when the controller 120 omits driving of a channel according to the embodiment described above, the controller 120 omits driving of, for example, intermediate channels, as illustrated in a middle portion of FIG. 5, to reduce a data amount. Here, the omission of driving results in reducing the possibility of a reduction in the quality of perceptual representation, as described above. Thus, the controller 120 performs adjustment to make a driving period of time (a period of time for which a haptic sensation is presented) longer with respect to a channel to be driven, as illustrated on the right in FIG. 5. Accordingly, the possibility of a reduction in the quality of perceptual representation such as the continuity or smoothness of movement of a perceptual location can also be reduced when driving is omitted.

On the basis of at least one of a movement speed or a size of spacing of arrangement of (that is, a distance between) the respective haptic presentation sections 210 to be driven, the controller 120 may determine to what extent the driving period of time is to be made longer than a period of time indicated by a haptic signal. Further, the controller 120 may control a period of time such that a driving-period-of-time difference between the respective haptic presentation sections 210 to be driven exhibits a value smaller than or equal to a certain value. The driving-period-of-time difference refers to a difference between a finish time at which driving of a first haptic presentation section 210 to be driven (for example, the haptic presentation section 210 corresponding to a start channel) is finished, and a start time at which driving of a second haptic presentation section 210 to be driven next (for example, the haptic presentation section 210 corresponding to a finish channel) is started.

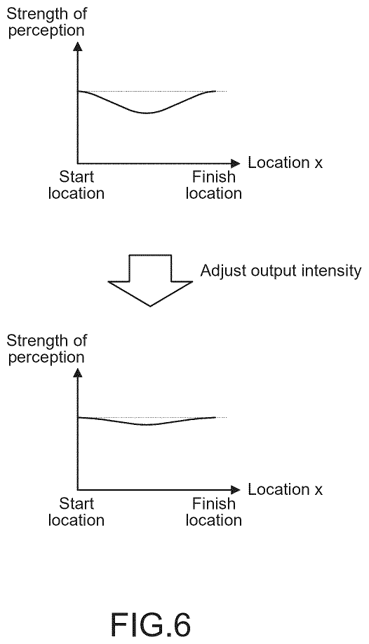

Note that the driving of a channel according to the first modification (that is, the adjustment to make a driving period of time longer) makes it possible to correct a strength of perception between the haptic presentation sections 210 to be driven (in particular, around a location intermediate between a start location at which presentation of a haptic sensation is started and a finish location at which the presentation of a haptic sensation is finished). FIG. 6 is a diagram used to describe a change in strength of perception according to the first modification of the present embodiment. In the example illustrated in an upper portion of FIG. 6, a degree of strength of perception at a location at which a haptic sensation is presented is illustrated, where the degree of strength of perception is assumed to be exhibited when driving of an intermediate channel is omitted and a start channel and a finish channel are driven sequentially with a time difference. When the adjustment to make a driving period of time longer is not performed, the strength of perception around the location intermediate between the start location and the finish location may be greatly reduced, as illustrated in the upper portion of FIG. 6. On the other hand, when the adjustment to make a driving period of time longer is performed, a reduction in the strength of perception around the location intermediate between the start location and the finish location can be decreased, as illustrated in a lower portion of FIG. 6.

### 3-2. Second Modification

Due to the above-described omission of driving, a data amount can be reduced, and a user perceives, due to apparent movement, as if a perceptual location were continuously moving on a skin of the user. However, the number of channels to be driven is small, and thus it is conceivable that a strength of perception could be greatly reduced, compared to when all of the channels are driven. Therefore, in a second modification, when the controller 120 omits driving of at least a portion of intermediate channels, the controller 120 increases an output intensity (a strength of haptic stimulation), compared to an intensity indicated by a haptic signal. This makes it possible to reduce the possibility of a reduction in a strength of perception of all the stimulation provided when a haptic sensation is presented, compared to before omission of driving.

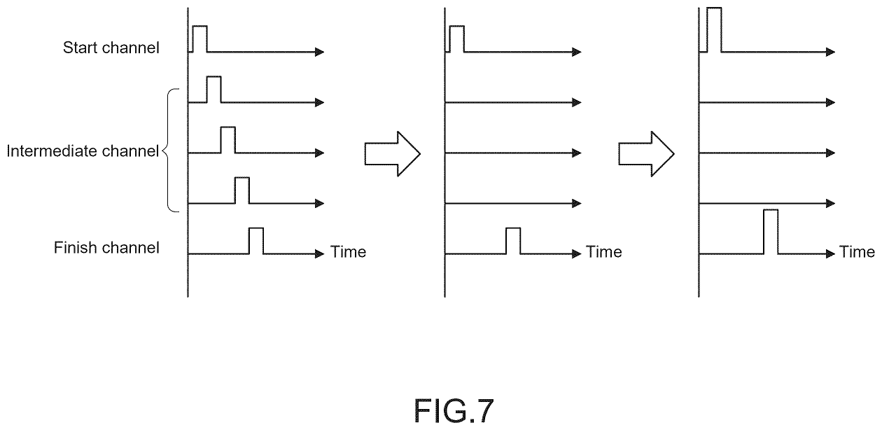

FIG. 7 is a diagram used to describe driving of a channel according to the second modification of the present embodiment. When driving is not omitted, all of a start channel, intermediate channels, and a finish channel are driven, as illustrated on the left in FIG. 7. On the other hand, when the controller 120 omits driving of a channel according to the embodiment described above, the controller 120 omits driving of, for example, intermediate channels, as illustrated in a middle portion of FIG. 7, to reduce a data amount. Here, the omission of driving results in reducing the possibility of a reduction in strength of perception, as described above. Thus, the controller 120 performs adjustment to increase a strength of perception with respect to a channel to be driven, as illustrated on the right in FIG. 7. Accordingly, the possibility of a reduction in a strength of perception of all the stimulation provided when a haptic sensation is presented can also be reduced when driving is omitted.

On the basis of at least one of a movement speed or a size of spacing of arrangement of (that is, a distance between) the respective haptic presentation sections 210 to be driven, the controller 120 may determine to what extent a degree of output intensity is to be increased.

### 3-3. Third Modification

When there is a decrease in a degree of contact of the haptic presentation section 210 corresponding to a driving-target channel with skin, the controller 120 may cancel omission of driving of a neighboring channel or increase an output intensity of the haptic presentation section 210 corresponding to a driving-target channel, in order not to lose a haptic quality.

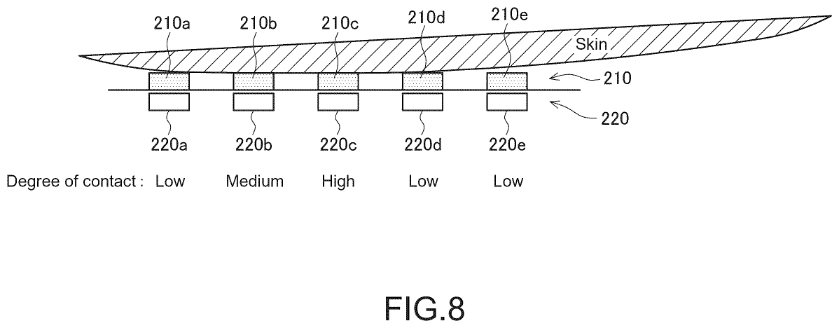

FIG. 8 is a diagram used to describe a degree of contact of the haptic presentation section 210 with skin according to a third modification of the present embodiment. The degree of contact of the haptic presentation section 210 with skin may be detected by a sensor 220 provided to a vibration presentation device. Specifically, a degree of contact of each of the haptic presentation sections 210a to 210e with skin may be detected by a corresponding one of sensors 220a to 220e provided to be situated on a side opposite to the skin, as viewed from the respective haptic presentation sections 210, as illustrated in, for example, FIG. 8.

The sensor 220 may be, for example, a pressure sensor. The haptic presentation section 210 is pressed by skin to press the sensor 220 according to the degree of contact of the haptic presentation section 210 with the skin. The controller 120 may determine whether the degree of contact of the haptic presentation section 210 is high, medium, or low from a pressure value detected by a corresponding sensor 220, using respective thresholds.

In the example illustrated in FIG. 8, the degree of contact of each of the haptic presentation sections 210a, 210d, and 210e is determined to be “low”, the degree of contact of the haptic presentation section 210b is determined to be “medium”, and the degree of contact of the haptic presentation section 210c is determined to be “high”. The controller 120 may perform a specified change in control on driving according to the above-described degree of contact in order not to lose a haptic quality when the haptic presentation section 210a corresponding to a start location and the haptic presentation section 210e corresponding to a finish location are scheduled to be driven due to omission of driving of intermediate channels (the haptic presentation sections 210b to 210d).

Specifically, for example, the controller 120 may increase an output intensity of at least one of the driving-target haptic presentation section 210a or the driving-target haptic presentation section 210e. Further, the controller 120 may cancel omission of driving of the haptic presentation section 210c, and may determine the haptic presentation section 210c as a driving target, where a degree of contact of the haptic presentation section 210c is higher from among the haptic presentation sections 210b to 210d of which driving is scheduled to be omitted (addition of a driving-target haptic presentation section). Furthermore, the controller 120 may determine the haptic presentation section 210b as a driving target instead of the haptic presentation section 210a of which a degree of contact is low, the haptic presentation section 210b neighboring with the haptic presentation section 210a and exhibiting a higher degree of contact than the haptic presentation section 210a.

### 3-4. Fourth Modification

As described above, a haptic signal may be data based on information regarding a motion or operation performed by a user. The haptic presentation system 1 according to the present embodiment may acquire a haptic signal based on information regarding a motion or operation performed by a user, and may present a haptic sensation in real time.

When, for example, a haptic presentation device is a mouse used for an operation input to a personal computer (PC), a haptic signal may be generated in real time in response to a cursor (such as a pseudo-finger) being brought into contact with a displayed object (such as a 3D object) when a user operates the mouse to operate the cursor (for example, three-dimensionally) displayed on a display section. The controller 120 may determine the haptic presentation section 210 of which driving is to be omitted, according to a movement speed of the cursor on the basis of such a haptic signal. In this case, the movement speed of the cursor is used as a movement speed of a perceptual location. The controller 120 may acquire the movement speed of the cursor from the haptic signal. Further, the operation of a cursor is used as an example in this case, but the present embodiment is not limited thereto. When, for example, a haptic sensation is presented according to an operation of scrolling, the controller 120 may determine, according to a speed of the scrolling, the haptic presentation section 210 of which driving is to be omitted.

### 3-5. Fifth Modification

It is conceivable that the ease of perception of an apparent movement could differ depending on a body part or an individual.

When, for example, a fingertip and an arm are compared, the fingertip exhibits a higher tactile spatial resolution, and this makes it easier to cause an apparent movement. On the other hand, the arm exhibits a low tactile spatial resolution, and this may result in not causing an apparent movement. Thus, the controller 120 may determine whether to perform omission of driving according to a body part to which haptic stimulation is presented.

Further, there are a person who easily perceives an apparent movement and a person who does not easily perceive an apparent movement. The controller 120 may perform adjustment according to a user to whom haptic stimulation is presented. Specifically, in the case of a user who does not easily perceive an apparent movement, the controller 120 performs adjustment such as reducing the number of channels of which driving is to be omitted, increasing an output intensity, or making a driving period of time longer. This makes it possible to reduce a data amount necessary for presentation of a haptic sensation while securing the ability to recreate presentation of a haptic sensation.

### 4. Supplement

The favorable embodiments of the present disclosure have been described above in detail with reference to the accompanying drawings. However, the present technology is not limited to these examples. It is clear that persons who have common knowledge in the technical field of the present disclosure could conceive various modifications or alterations within the scope of a technical idea according to an embodiment of the present disclosure. It is understood that of course such modifications or alterations also fall under the technical scope of the present disclosure.

For example, the embodiments and modifications described above may be combined as appropriate.

Further, at least one computer program used to cause hardware such as a CPU, a ROM, and a RAM to provide a function of an apparatus by which the haptic presentation system 1 described above is implemented can also be created, the hardware being included in the apparatus by which the haptic presentation system 1 is implemented. Furthermore, a computer-readable storage medium that has stored therein the at least one computer program is also provided.

Further, the effects described herein are not limitative, but are merely descriptive or illustrative. In other words, the technology according to the present disclosure may provide other effects apparent to those skilled in the art from the description herein, in addition to, or instead of the effects described above.

Note that the present technology may also take the following configurations.
(1) An information processing apparatus, including
a controller that performs control including
   determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished, and
   generating a control signal used to drive driving-target haptic presentation sections sequentially.
(2) The information processing apparatus according to (1), in which
when the movement speed is less than a first specified value, the controller performs determination to generate the control signal, the determination being determining, without the omission of driving, that the haptic presentation section corresponding to the start location, the haptic presentation section corresponding to the finish location, and all of the at least one haptic presentation section situated between the start location and the finish location are driving targets.
(3) The information processing apparatus according to (1), in which
when the movement speed is greater than a first specified value, the controller determines that a portion of the at least one haptic presentation section situated between the start location and the finish location is a haptic presentation section of which driving is to be omitted, and
the controller performs determination to generate the control signal, the determination being determining that the haptic presentation section corresponding to the start location, the haptic presentation section corresponding to the finish location, and the haptic presentation section being included in the at least one haptic presentation section situated between the start location and the finish location and being other than the haptic presentation section of which driving is to be omitted are driving targets.
(4) The information processing apparatus according to (3), in which
when the movement speed is greater than a second specified value that is larger than the first specified value, the controller determines that all of the at least one haptic presentation section situated between the start location and the finish location is haptic presentation section of which driving is to be omitted, and
the controller performs determination to generate the control signal, the determination being determining that the haptic presentation section corresponding to the start location and the haptic presentation section corresponding to the finish location are driving targets.
(5) The information processing apparatus according to any one of (2) to (4), in which
the specified value differs depending on spacing of arrangement of the respective haptic presentation sections.
(6) The information processing apparatus according to any one of (1) to (5), in which
when the controller omits driving of the at least one haptic presentation section, the controller performs adjustment upon generation of the control signal, the adjustment including making a driving period of time for a driving-target haptic presentation section longer than a period of time indicated by the haptic signal.
(7) The information processing apparatus according to (6), in which
the controller adjusts a length of the driving period of time on the basis of a size of spacing of arrangement of the driving-target haptic presentation sections.
(8) The information processing apparatus according to any one of (1) to (7), in which
when the controller omits driving of the at least one haptic presentation section, the controller performs adjustment upon generation of the control signal, the adjustment including making an output intensity of a driving-target haptic presentation section higher than an intensity indicated by the haptic signal.
(9) The information processing apparatus according to (8), in which
the controller adjusts the output intensity on the basis of a size of spacing of arrangement of the driving-target haptic presentation sections.
(10) The information processing apparatus according to any one of (1) to (9), in which
in response to a decrease in a degree of contact of a driving-target haptic presentation section with skin, the controller performs adjustment including making an output intensity of the driving-target haptic presentation section higher than an intensity indicated by the haptic signal.
(11) The information processing apparatus according to any one of (1) to (10), in which
in response to a decrease in a degree of contact of a driving-target haptic presentation section with skin, the controller cancels the determination performed on the omission of driving and performs addition of a driving-target haptic presentation section.
(12) The information processing apparatus according to any one of (1) to (11), in which
the controller determines whether to perform the omission of driving according to a body part to which haptic stimulation is presented.
(13) The information processing apparatus according to any one of (1) to (12), in which
upon generation of the control signal, the controller performs adjustment according to a user to whom haptic stimulation is presented.
(14) The information processing apparatus according to any one of (1) to (13), in which
the controller performs control including outputting the generated control signal to a haptic presentation device that includes a plurality of haptic presentation sections.
(15) An information processing method that is performed by a processor, the information processing method including:
determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished; and
generating a control signal used to drive driving-target haptic presentation sections sequentially.
(16) A program that causes a computer to operate as a controller that performs control including
determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished, and
generating a control signal used to drive driving-target haptic presentation sections sequentially.

### REFERENCE SIGNS LIST

1 haptic presentation system
110 input section
120 controller
130 storage
210 haptic presentation section

1. An information processing apparatus, comprising
a controller that performs control including
determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished, and
generating a control signal used to drive driving-target haptic presentation sections sequentially.

2. The information processing apparatus according to claim 1, wherein
when the movement speed is less than a first specified value, the controller performs determination to generate the control signal, the determination being determining, without the omission of driving, that the haptic presentation section corresponding to the start location, the haptic presentation section corresponding to the finish location, and all of the at least one haptic presentation section situated between the start location and the finish location are driving targets.

3. The information processing apparatus according to claim 1, wherein
when the movement speed is greater than a first specified value, the controller determines that a portion of the at least one haptic presentation section situated between the start location and the finish location is a haptic presentation section of which driving is to be omitted, and
the controller performs determination to generate the control signal, the determination being determining that the haptic presentation section corresponding to the start location, the haptic presentation section corresponding to the finish location, and the haptic presentation section being included in the at least one haptic presentation section situated between the start location and the finish location and being other than the haptic presentation section of which driving is to be omitted are driving targets.

4. The information processing apparatus according to claim 3, wherein
when the movement speed is greater than a second specified value that is larger than the first specified value, the controller determines that all of the at least one haptic presentation section situated between the start location and the finish location is haptic presentation section of which driving is to be omitted, and
the controller performs determination to generate the control signal, the determination being determining that the haptic presentation section corresponding to the start location and the haptic presentation section corresponding to the finish location are driving targets.

5. The information processing apparatus according to claim 2, wherein
the specified value differs depending on spacing of arrangement of the respective haptic presentation sections.

6. The information processing apparatus according to claim 1, wherein
when the controller omits driving of the at least one haptic presentation section, the controller performs adjustment upon generation of the control signal, the adjustment including making a driving period of time for a driving-target haptic presentation section longer than a period of time indicated by the haptic signal.

7. The information processing apparatus according to claim 6, wherein
the controller adjusts a length of the driving period of time on a basis of a size of spacing of arrangement of the driving-target haptic presentation sections.

8. The information processing apparatus according to claim 1, wherein
when the controller omits driving of the at least one haptic presentation section, the controller performs adjustment upon generation of the control signal, the adjustment including making an output intensity of a driving-target haptic presentation section higher than an intensity indicated by the haptic signal.

9. The information processing apparatus according to claim 8, wherein
the controller adjusts the output intensity on a basis of a size of spacing of arrangement of the driving-target haptic presentation sections.

10. The information processing apparatus according to claim 1, wherein
in response to a decrease in a degree of contact of a driving-target haptic presentation section with skin, the controller performs adjustment including making an output intensity of the driving-target haptic presentation section higher than an intensity indicated by the haptic signal.

11. The information processing apparatus according to claim 1, wherein
in response to a decrease in a degree of contact of a driving-target haptic presentation section with skin, the controller cancels the determination performed on the omission of driving and performs addition of a driving-target haptic presentation section.

12. The information processing apparatus according to claim 1, wherein
the controller determines whether to perform the omission of driving according to a body part to which haptic stimulation is presented.

13. The information processing apparatus according to claim 1, wherein
upon generation of the control signal, the controller performs adjustment according to a user to whom haptic stimulation is presented.

14. The information processing apparatus according to claim 1, wherein
the controller performs control including outputting the generated control signal to a haptic presentation device that includes a plurality of haptic presentation sections.

15. An information processing method that is performed by a processor, the information processing method comprising:
determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished; and
generating a control signal used to drive driving-target haptic presentation sections sequentially.

16. A program that causes a computer to operate as a controller that performs control including
determining, according to a movement speed of a perceptual location acquired from a haptic signal, a haptic presentation section of which driving is to be omitted, the haptic presentation section of which driving is to be omitted being included in at least one haptic presentation section situated between a haptic presentation section corresponding to a start location at which presentation of haptic stimulation is started and a haptic presentation section corresponding to a finish location at which the presentation of haptic stimulation is finished, and
generating a control signal used to drive driving-target haptic presentation sections sequentially.
